(19) United States
(12) Patent Application Publication
(10) Pub. No.: US 2009/0218542 A1
(43) Pub. Date: Sep. 3, 2009

(54) ANISOTROPIC SILICON ETCHANT COMPOSITION

(75) Inventors: Kenji Isami, Osaka-shi (JP); Mayumi Kimura, Osaka-shi (JP); Tetsuo Aoyama, Osaka-shi (JP); Tsuguhiro Tago, Ojiya-shi (JP)

Correspondence Address: DITTHAVONG MORI & STEINER, P.C., 918 Prince St., Alexandria, VA, 22314, US

(73) Assignees: Hayashi Pure Chemical Ind, Ltd., Osaka (JP); SANYO ELECTRIC CO., LTD., Osaka (JP); Sanyo Semiconductor Co., Ltd., Gunma (JP); SANYO Semiconductor Manufacturing Co., Ltd, Niigata (JP)

(21) Appl. No.: 12/393,090

(22) Filed: Feb. 26, 2009

(30) Foreign Application Priority Data
Feb. 28, 2008 (JP) 2008-047979

(51) Int. Cl. C09K 13/02; C09K 13/00

(52) U.S. Cl. 252/79.5; 252/79.1

(57) ABSTRACT

An etchant composition contains (a) an alkaline compound mixture of an organic alkaline compound and inorganic alkaline compound and (b) a silicon-containing compound. The organic alkaline compound is composed of one or more ingredients from quaternary ammonium hydroxide and ethylenediamine. The inorganic alkaline compound is composed of one or more ingredients from sodium hydroxide, potassium hydroxide, ammonia and hydrazine. The silicon-containing inorganic compound is composed of one or more ingredients from metal silicon, fumed silica, colloidal silica, silica gel, silica sol, diatomaceous earth, acid clay and activated clay, and the silicon-containing organic compound is composed of one or more ingredients from quaternary ammonium salts of alkyl silicate and quaternary ammonium salts of alkyl silicic acid.

### BACKGROUND OF THE INVENTION

1. Field of the Invention

The present invention relates to an anisotropic silicon etchant composition used in a surface treatment process in manufacturing processes of various silicon devices, and, more particularly, to an anisotropic silicon etchant composition suitable for manufacture of semiconductor devices having a silicon substrate on which a metal film is formed.

2. Description of Background Art

With the recent improvement of micromachining techniques, various silicon devices have found wide application in semiconductor devices used in a variety of devices, such as a thermal sensor, pressure sensor, acceleration sensor and angular velocity sensor. Such silicon devices have been required to furthermore increase their density, sensitivity and functionality while decreasing their size, and in order to satisfy these various demands, the silicon devices are manufactured by using microfabrication technology including micromachining techniques. The micromachining techniques include anisotropic etching used for forming silicon into a desired three-dimensional shape.

A conventional wet etching method of a single crystal silicon substrate is mainly performed with an acid etchant that is an aqueous solution mixture of hydrofluoric acid, nitric acid and acetic acid or with an alkaline etchant that is an aqueous solution of potassium hydroxide, tetramethylammonium hydroxide, hydrazine or the like. The acid etchant, which isotropically etches silicon single crystal substrates irrespective of the crystal orientation of the substrates, is often used to uniformly etch the surface of a silicon wafer sliced from a single crystal silicon ingot. On the other hand, the alkaline etchant etches a single crystal silicon substrate at an etching rate depending upon the crystal orientation of the substrate and therefore can perform anisotropic etching of silicon. With the use of this anisotropy, wet etching with the alkaline etchant can form complex three-dimensional silicon devices.

Conventional anisotropic etching techniques of silicon with alkaline etchants are disclosed as follows:
i) Japanese unexamined patent publication No. 1974-076479 uses an alkaline etchant mixture of hydrazine hydrate and anhydrous ethylenediamine at a volume ratio of 1:0.5 to 1. This etchant still has an anisotropic etching property as brought about by conventionally used potassium hydroxide, sodium hydroxide and hydrazine while suppressing generation of micro-pyramids.
ii) Japanese unexamined patent publication No. 1993-102124 discloses ways of equating the etching rates that usually differ depending on their position in an etching bath which is filled with an etchant composed of an alkaline aqueous solution and alcohol.
iii) Japanese Examined Patent Application Publication No. 1996-31452 discloses a silicon etching agent containing an alkaline compound and a high flash point alcohol. The etching agent is used at a temperature below its flash point, thereby etching a silicon substrate having a p-doped area with high selectivity so that the silicon is dissolved and the p-doped area remains undissolved.
iv) Japanese patent No. 3444009 discloses an alkaline etching agent comprising three ingredients, potassium hydroxide, hydrazine and water; the alkaline etching agent containing at least 0.3% potassium hydroxide. This alkaline etching agent makes the etched surface even and makes the etched bottom surface parallel with the main surface of a substrate. Furthermore, the alkaline etching agent etches silicon at a high etching rate and corrodes only an extremely small area of a silicon oxide film that serves as a mask.
v) Japanese patent No. 3525612 discloses etching agents made of at least two alkalis, such as potassium hydroxide and ethylenediamine, potassium hydroxide and tetramethylammonium hydroxide, and potassium hydroxide and ammonia, each can etch a silicon wafer along different crystal plane orientations at its own highest etching rate. These etching agents can obtain smooth etched surfaces.
vi) Japanese unexamined patent publication No. 2000-349063 discloses a technique for enhancing the etching rate and obtaining even etched surfaces by etching silicon with a potassium hydroxide solution with a reducing agent added thereto under pressure.

In the recent rapidly-growing MEMS (Micro Electro Mechanical Systems) field, anisotropic etching techniques are also used to process silicon, and many kinds of alkaline etchants have been developed which are different in etching rate ratios of silicon crystal planes in order to conform to all silicon shapes which differ depending on the kind of manufacturing electronics devices (some etchants exhibit great anisotropy, for example, their etching rates are 100 times different according to crystal orientations) and which are different in the degree of smoothness of etched surfaces (the bottom surface and wall surfaces).

By the way, the material of electrodes and wires of conventional silicon semiconductors are generally aluminum or aluminum alloy; however, the aluminum and aluminum alloy are more likely to be subject to corrosion by alkaline etchants, and therefore the electrodes and wires made of aluminum or aluminum alloy require some measures to prevent corrosion.

When semiconductor devices having aluminum or aluminum alloy are manufactured with an alkaline etchant, the following methods have been conventionally employed:
1) Aluminum or aluminum alloy is deposited after anisotropic etching is performed on silicon with the alkaline etchant.
2) A protective film (e.g., oxide film), which is resistant to the anisotropic alkaline etchant, is formed to protect aluminum or aluminum alloy.
3) Electrode materials are changed from aluminum or aluminum alloy to a metal resistant to the anisotropic alkaline etchant, such as titanium (Ti), tungsten (W), molybdenum (Mo), tantalum (Ta), chrome (Cr).
4) Silicon or an oxidizing agent is added to the anisotropic alkaline etchant to reduce the amount of aluminum and aluminum alloy to be etched (see Japanese unexamined patent publications No. 1992-370932 and No. 2004-119674).
5) A reducing agent is added to the anisotropic etchant of inorganic alkali or organic alkali to reduce the amount of aluminum and aluminum alloy to be etched and increase the etching rate (see Japanese unexamined patent publication No.2007-214456).

### SUMMARY OF THE INVENTION

As a result of intensive study, the inventors of the present invention found that the anisotropic silicon etchant composition that is an aqueous solution containing (a) an alkaline compound mixture of at least one kind of organic alkali and at least one kind of inorganic alkali and (b) a silicon-containing compound can selectively etch silicon without corroding aluminum and aluminum alloy used as a material of electrodes and wires, while maintaining its various advantages, such as anisotropic etching properties, reduction of damage to a silicon oxide film used as a mask material and suitability to semiconductor processes. The inventors further found that the anisotropic silicon etchant composition with (c) a reducing agent added thereto has excellent properties, such as a high etching rate of silicon and anticorrosive effect on aluminum and aluminum alloy. In view of the advantages, the inventors have reached the present invention.

The organic alkaline compound is preferably composed of one or more ingredients selected from the group consisting of quaternary ammonium hydroxide and ethylenediamine.

The inorganic alkaline compound is preferably composed of one or more ingredients selected from the group consisting of sodium hydroxide, potassium hydroxide, ammonia and hydrazine.

The silicon-containing compound is preferably composed of at least one of a silicon-containing inorganic compound and a silicon-containing organic compound.

The silicon-containing inorganic compound is preferably composed of one or more ingredients selected from the group consisting of metal silicon, fumed silica, colloidal silica, silica gel, silica sol, diatomaceous earth, acid clay and activated clay, while the silicon-containing organic compound is preferably composed of one or more ingredients selected from the group consisting of quaternary ammonium salts of alkyl silicate and quaternary ammonium salts of alkyl silicic acid.

Preferably, the anisotropic silicon etchant composition of the present invention further contains (c) a reducing compound.

The reducing compound is preferably composed of at least one ingredient selected from the group consisting of hydroxylamines, hydrazines, phosphates, hypophosphites, reducing sugars, ascorbic acid and glyoxylic acid and derivatives thereof.

The reducing compound is preferably composed of one or more ingredients selected from the group consisting of hydroxylamine, diethylhydroxylamine, hydroxylamine sulfate, hydroxylamine chloride, hydroxylamine oxalate, hydroxylamine phosphate, dimethylhydroxylamine hydrochloride, hydrazine, hydrazine monohydrochloride, hydrazine dihydrochloride, hydrazine sulfate, hydrazine carbonate, hydrazine phosphate, methyl hydrazine, methylhydrazine sulfate, ammonium dihydrogen phosphate, ammonium hypophosphite, maltose, lactose, melibiose, cellobiose, isomalto oligosaccharide, ascorbic acid and glyoxylic acid.

The present invention makes it possible to provide an anisotropic silicon etchant composition having an extremely high etching rate of silicon, high-level anticorrosive effect on aluminum and aluminum alloy used as a material of electrodes and wires, high etching selectivity and high etching capability. The use of the etchant composition of the present invention can greatly contribute to productivity of manufacturing processes using microfabrication technology of silicon.

### DESCRIPTION OF THE PREFERRED EMBODIMENT

The first aspect of the present invention provides an anisotropic silicon etchant that is an aqueous solution containing an alkaline compound, made by blending at least one kind of organic alkaline compound and at least one kind of inorganic alkaline compound, and a silicon-containing compound. The second aspect of the present invention provides an anisotropic silicon etchant that is an aqueous solution composed of the anisotropic silicon etchant of the first aspect and a reducing agent.

The alkaline compound used in the present invention may be any strong alkaline compounds irrespective of whether they are organic or inorganic and can be conventional alkaline compounds having desired etching properties. Preferable examples of the organic alkaline compound are tetramethylammonium hydroxide, choline hydroxide and ethylenediamine, while preferable examples of the inorganic alkaline compound are sodium hydroxide, potassium hydroxide, ammonia and hydrazine. The alkaline compound is made by blending at least one kind of organic alkaline compound and at least one kind of inorganic alkaline compound before use. The anisotropic silicon etchant used in the present invention contains 0.01 wt % to 25 wt % organic alkaline compound and 0.01 wt % to 50 wt % inorganic alkaline compound.

By setting the concentrations of the organic and inorganic alkaline compounds to the above-described ranges, the etchant can meet fundamental requirements in order to realize an etchant composition having the etching properties, which are unique to the etchant composition of the present invention, that is, high etching selectivity and high etching capability.

The silicon-containing compound used in the present invention is an silicon-containing inorganic compound, such as metal silicon, fumed silica, colloidal silica, silica gel, silica sol, diatomaceous earth, acid clay and activated clay, or/and an silicon-containing organic compound, such as alkyl silicate or alkyl silicic acid. The concentration of the silicon-containing compound in the anisotropic silicon etchant used in the present invention is 0.01 wt % to 30 wt %, and preferably 0.01 wt % to 20 wt %. It is found that the anisotropic silicon etchant containing less than 0.01 wt % silicon-containing compound provides little anticorrosive effect to aluminum and aluminum alloy, but the anisotropic silicon etchant containing over 30 wt % silicon-containing compound unfavorably lowers the etching rate of silicon.

The reducing compound used in the present invention is composed of one or more ingredients selected from hydroxylamines, hydrazines, phosphates, hypophosphites, reducing sugars, ascorbic acid and glyoxylic acid and derivatives thereof. More specifically, the reducing compound may be hydroxylamine, diethylhydroxylamine, hydroxylamine sulfate, hydroxylamine carbonate, hydroxylamine chloride, hydroxylamine oxalate, hydroxylamine phosphate, hydroxylamine-o-sulfonic acid, dimethylhydroxylamine hydrochloride, hydrazine, hydrazine monohydrochloride, hydrazine dihydrochloride, hydrazine sulfate, hydrazine carbonate, hydrazine dihydrobromide, hydrazine phosphate, methyl hydrazine, methylhydrazine sulfate, ammonium dihydrogen phosphate, ammonium hypophosphite, maltose, lactose, melibiose, cellobiose, isomalto oligosaccharide, ascorbic acid, glyoxylic acid or the like. The particularly favorable reducing compound from the above is hydroxylamine, hydroxylamine sulfate, hydroxylamine carbonate, hydroxylamine chloride, hydroxylamine oxalate, hydroxylamine phosphate, dimethylhydroxylamine hydrochloride, hydrazine or the like.

The reducing compound can be made of a single kind of the above ingredients or a combination of two or more ingredients. The concentration of the reducing compound is appropriately determined according to the concentration of the alkaline compound and silicon-containing compound in the etchant composition, and is preferably 0.1 wt % to 50 wt %. The etchant containing less than 0.1 wt % reducing compound has a low etching rate and cannot obtain a desired etching rate. The etchant containing over 50 wt % reducing compound is not preferable in handleability because the reducing compound causes precipitation and solidification of crystal and makes the etchant composition flammable.

In addition to the above ingredients, there is no problem to add a conventionally-used anticorrosive agent to the anisotropic silicon etchant of the present invention. The anticorrosive agent added to the present invention may be sugars, sugar alcohols and catechols. The sugars and sugar alcohols include arabinose, galactose, xylitol, sorbitol, mannitol, mannose, glucose, lactose, maltose, inositol, xylose, threose, erythrose, ribose, ribulose, xylulose, tagatose, allose, gulose, idose, talose, sorbose, psicose, fructose, threitol, erythritol, adonitol, arabinitol, talitol, iditol, dulcitol and so on. The catechols include pyrocatechol, butylpyrocatechol and so on. The concentration of the anticorrosive agent in the anisotropic silicon etchant is appropriately determined according to the ingredient of the alkaline compound, silicon-containing compound and reducing agent and their concentrations, and is preferably 0.1 wt % to 20 wt %. The etchant containing less than 0.1 wt % anticorrosive agent cannot provide the anticorrosive effect to the aluminum and aluminum alloy, while more than 20 wt % anticorrosive agent is not preferable in handleability because it causes precipitation and solidification of crystal.

Furthermore, a surfactant and solvent can be added to the anisotropic silicon etchant of the present invention, if necessary, in order to improve wettability. As the surfactant, for example, any one of cationic, anionic and nonionic surfactants is feasible, and the concentration of the surfactant is not specifically limited. As the solvent, alcohol, glycerol or glycerol derivative is favorable. The alcohol may be methanol, ethanol, isopropylalcohol or the like. The glycerol derivative may be diglycerin, polyglycerin or the like.

The anisotropic etching employed in the present invention to process silicon is preferably performed at a temperature ranging from room temperature to below the boiling point of the etchant; however, if a higher etching rate is required, the anisotropic etching can be performed at still higher temperatures but under pressure.

When the conventional anisotropic alkaline etchant is used to etch a silicon substrate in which electrodes made of metal resistant to an alkaline anisotropic etchant, such as titanium (Ti), tungsten (W), molybdenum (Mo), tantalum (Ta), chrome (Cr), instead of aluminum or aluminum alloy, are formed, the alkali-resistant metal electrodes (or metal film) formed on a large part of the silicon substrate sometimes may hinder etching; however, the anisotropic silicon etchant of the present invention does not cause such a phenomenon.

Additionally, a dry etching technique generally used to finish electrodes so as to be minuscule in size may cause damage to the surface of the silicon substrate and the damage may hinder etching; however, the anisotropic silicon etchant of the present invention does not cause such a phenomenon.

Furthermore, since the anisotropic silicon etchant of the present invention can etch a silicon oxide film; the etchant can remove native oxides generated on the silicon substrate while etching the silicon substrate, and therefore a process for cleaning silicon with a hydrofluoric acid-base solution which is generally performed before the etching process can be omitted.

Accordingly, the anisotropic silicon etchant of the present invention having the aforementioned characteristics is suitably used, in the MEMS field including a wet etching process of silicon, as a liquid etchant for manufacturing various silicon devices used in valves, nozzles, printer heads, semiconductor sensors for detecting various physical quantities such as a flow rate, pressure and acceleration, and other devices.

### EXAMPLE

A more detailed description about the present invention will be made with examples and comparative examples; however, the present invention is not limited to the examples.

### EXAMPLES

As an anisotropic silicon etchant composition satisfying the requirements of the present invention, etchant compositions shown as examples 1 to 8 in Table 1 were prepared and examined for their characteristics under predetermined conditions.

First, the anisotropic silicon etchant composition of example 1 was an aqueous solution containing 5.0 wt % tetramethylammonium hydroxide (hereinafter, abbreviated to TMAH) as organic alkali, 1.0 wt % potassium hydroxide as inorganic alkali and 3.0 wt % colloidal silica as a silicon-containing compound.

Next, single-crystal silicon wafer samples, made for measuring the etching rates, having an orientation in (100) plane or an orientation in (111) plane were immersed in the etchant composition of example 1 for one hour at 75° C.

After the samples were rinsed with ultrapure water and dried, their etching rates were obtained by measuring the etching amounts of the single-crystal silicon along the orientation in (100) plane and the orientation in (111) plane.

In addition, a wafer on which an aluminum alloy (Al—Cu) film was formed was etched with the same etchant composition in the same manner to obtain the aluminum etching rate. The results are shown in Table 1.

The etchant composition of example 2 was composed of the same ingredients at the same ratio as the etchant composition of example 1 except that the colloidal silica was replaced with fumed silica as a silicon-containing compound. With the etchant composition and under the same conditions as the example 1, silicon wafer samples were subjected to etching to measure the silicon etching rates, while a silicon wafer having an aluminum alloy (Al—Cu) film was etched to measure the aluminum etching rate. The results are shown in Table 1.

The etchant composition of example 3 was the same as that of example 1, but was used under different conditions (temperature was changed from 75° C. to 85° C., but the other conditions were not changed). With the etchant composition, silicon wafer samples were subjected to etching to measure the silicon etching rates, while a silicon wafer having an aluminum alloy (Al—Cu) film was etched to measure the aluminum etching rate. The results are shown in Table 1.

The etchant compositions of examples 4 and 5 were composed of the same ingredients as those of the etchant composition of example 1, but the ratios of TMAH and inorganic alkaline compound were different from example 1. With the etchant compositions and under the same conditions as example 1, silicon wafer samples were subjected to etching to measure the silicon etching rates, while silicon wafers having an aluminum alloy (Al—Cu) film were etched to measure the aluminum etching rates. The results are shown in Table 1.

The etchant composition of example 6 was composed of the same ingredients at the same ratio as example 1 and further contained 1.0 wt % hydroxylamine as a reducing compound. With the etchant composition and under the same conditions as example 1, silicon wafer samples were subjected to etching to measure the silicon etching rates, while a silicon wafer having an aluminum alloy (Al—Cu) film was etched to measure the aluminum etching rate. The results are shown in Table 1.

The etchant composition of example 7 was composed of the same ingredients at the same ratio as example 1 and further contained hydroxylamine as a reducing compound at a higher ratio (5.0 wt %) than example 6. With the etchant composition and under the same conditions as example 1, silicon wafer samples were subjected to etching to measure the silicon etching rates, while a silicon wafer having an aluminum alloy (Al—Cu) film was etched to measure the aluminum etching rate. The results are shown in Table 1.

The etchant composition of example 8 was composed of the same ingredients at the same ratio as example 1 and further contained 1.0 wt % maltose as a reducing compound. With the etchant composition and under the same conditions as example 1, silicon wafer samples were subjected to etching to measure the silicon etching rates, while a silicon wafer having an aluminum alloy (Al—Cu) film was etched to measure the aluminum etching rate. The results are shown in Table 1.

### [Table 1]

The results shown in Table 1 demonstrate that the etchant compositions of examples 1 to 8 that meet the requirements of the present invention can etch the silicon with higher selectivity and at higher etching rate than the aluminum.

### COMPARATIVE EXAMPLES

For the purpose of comparing with the etchant compositions of the present invention, the following etchant compositions were prepared, as shown in Table 2:
1) an etchant composition containing an organic alkaline compound, but not inorganic alkaline compound or silicon-containing compound (comparative example 1);
2) an etchant composition containing an organic alkaline compound and inorganic alkaline compound, but not silicon-containing compound (comparative example 2);
3) an etchant composition containing an organic alkaline compound and silicon-containing compound, but not inorganic alkaline compound (comparative example 3);
4) an etchant composition containing an organic alkaline compound and reducing compound, but not inorganic alkaline compound or silicon-containing compound (comparative example 4);
5) an etchant composition containing an organic alkaline compound, inorganic alkaline compound and reducing compound, but not silicon-containing compound (comparative example 5); and
6) an etchant composition containing an organic alkaline compound, silicon-containing compound and reducing compound, but not inorganic alkaline compound (comparative example 6).
   With these etchant compositions and under the same conditions as example 1, silicon wafer samples were subjected to etching to measure the silicon etching rates, while silicon wafers having an aluminum alloy (Al—Cu) film were etched to measure the aluminum etching rate. The results are shown in Table 2.

### [Table 2]

As shown in Table 2, the etchant compositions of comparative examples 1 to 6, which do not meet the requirement of the present invention, have greater aluminum etching rates than silicon etching rates (comparative examples 1, 2, 4, 5), or have greater silicon etching rates than the aluminum etching rates but the differences therebetween are small (comparative examples 3, 6), thereby demonstrating that the etchant compositions cannot selectively etch silicon or have inferior performance.

Although an aluminum alloy (Al—Cu) film formed on silicon wafers was taken as an example to be etched with the above-mentioned etchant composition examples, the present invention is not limited to the aluminum alloy film but also applicable to etch aluminum films.

The present invention is not limited to the above-described examples even in other respects. It is to be understood that various applications and modifications to the kind of ingredients as an organic alkaline compound, inorganic alkaline compound, silicon-containing compound and reducing compound, the ratio of the ingredients and the etching conditions, may occur within the scope of the invention.

### INDUSTRIAL APPLICABILITY

According to the aforementioned present invention, it is possible to provide an anisotropic silicon etchant composition having a significantly high etching rate to silicon while having high-level anticorrosive effect on aluminum and aluminum alloy used as a material for electrodes and wires, and high etching selectivity and high etching capability. The use of the etchant composition of the present invention can greatly improve the efficiency of microfabrication of silicon.

Therefore, the present invention has a wide applicability to the silicon-wafer microfabrication field.

TABLE 1

| | ALKALINE COMPOUNDS | | | | | SILICON | | |
|---|---|---|---|---|---|---|---|---|
| | ORGANIC | INORGANIC | SILICON- | | | ETCHING RATE | | ALUMINUM |
| | ALKALINE | ALKALINE | CONTAINING | REDUCING | | (100) | (111) | ETCHING |
| | COMPOUND | COMPOUND | COMPOUND | COMPOUND | ET* | PLANE | PLANE | RATE |
| | (wt %) | (wt %) | (wt %) | (wt %) | (° C.) | (μm/min.) | (μm/min.) | (nm/min.) |
| EXAMPLE 1 | TMAH | POTASSIUM | COLLOIDAL | — | 75 | 0.51 | 0.05 | 0.1 OR LESS |
| | (5.0) | HYDROXIDE (1.0) | SILICA (3.0) | | | | | |
| EXAMPLE 2 | TMAH | POTASSIUM | FUMED | — | 75 | 0.53 | 0.04 | 0.1 OR LESS |
| | (5.0) | HYDROXIDE (1.0) | SILICA (3.0) | | | | | |
| EXAMPLE 3 | TMAH | POTASSIUM | COLLOIDAL | — | 85 | 0.75 | 0.07 | 0.1 OR LESS |
| | (5.0) | HYDROXIDE (1.0) | SILICA (3.0) | | | | | |
| EXAMPLE 4 | TMAH | POTASSIUM | COLLOIDAL | — | 75 | 0.50 | 0.06 | 0.1 |
| | (1.6) | HYDROXIDE (3.1) | SILICA (3.0) | | | | | |
| EXAMPLE 5 | TMAH | POTASSIUM | COLLOIDAL | — | 75 | 0.92 | 0.09 | 0.6 |
| | (10.0) | HYDROXIDE (1.0) | SILICA (2.0) | | | | | |
| EXAMPLE 6 | TMAH | POTASSIUM | COLLOIDAL | HYDROXYL | 75 | 0.89 | 0.11 | 0.1 OR LESS |
| | (5.0) | HYDROXIDE (1.0) | SILICA (3.0) | AMINE (1.0) | | | | |
| EXAMPLE 7 | TMAH | POTASSIUM | COLLOIDAL | HYDROXYL | 75 | 1.43 | 0.16 | 0.1 OR LESS |
| | (5.0) | HYDROXIDE (1.0) | SILICA (3.0) | AMINE (5.0) | | | | |
| EXAMPLE 8 | TMAH | POTASSIUM | COLLOIDAL | MALTOSE | 75 | 0.69 | 0.06 | 0.1 OR LESS |
| | (5.0) | HYDROXIDE (1.0) | SILICA (3.0) | (1.0) | | | | |

ET*: ETCHING TEMPERATURE

TABLE 2

| | ALKALINE COMPOUNDS | | | | | SILICON | | |
|---|---|---|---|---|---|---|---|---|
| | ORGANIC | INORGANIC | SILICON- | | | ETCHING RATE | | ALUMINUM |
| | ALKALINE | ALKALINE | CONTAINING | REDUCING | | (100) | (111) | ETCHING |
| | COMPOUND | COMPOUND | COMPOUND | COMPOUND | ET* | PLANE | PLANE | RATE |
| | (wt %) | (wt %) | (wt %) | (wt %) | (° C.) | (μm/min.) | (μm/min.) | (nm/min.) |
| COMPARATIVE | TMAH | — | — | — | 75 | 0.52 | 0.07 | 1000 |
| EXAMPLE 1 | (5.0) | | | | | | | |
| COMPARATIVE | TMAH | POTASSIUM | — | — | 75 | 1.13 | 0.09 | 1800 |
| EXAMPLE 2 | (5.0) | HYDROXIDE (1.0) | | | | | | |
| COMPARATIVE | TMAH | — | COLLOIDAL | — | 75 | 0.44 | 0.07 | 41 |
| EXAMPLE 3 | (5.0) | | SILICA (3.0) | | | | | |
| COMPARATIVE | TMAH | — | — | HYDROXYL | 75 | 0.78 | 0.12 | 3000 |
| EXAMPLE 4 | (5.0) | | | AMINE (1.0) | | | | |
| COMPARATIVE | TMAH | POTASSIUM | — | HYDROXYL | 75 | 1.55 | 0.14 | 6300 |
| EXAMPLE 5 | (5.0) | HYDROXIDE (1.0) | | AMINE (1.0) | | | | |
| COMPARATIVE | TMAH | — | COLLOIDAL | HYDROXYL | 75 | 0.70 | 0.09 | 40 |
| EXAMPLE 6 | (5.0) | | SILICA (3.0) | AMINE (1.0) | | | | |

*ET: ETCHING TEMPERATURE

What is claimed is:

1. An anisotropic silicon etchant composition being an aqueous solution and comprising:
(a) an alkaline compound mixture of an organic alkaline compound and an inorganic alkaline compound; and
(b) a silicon-containing compound.

2. The anisotropic silicon etchant composition according to claim 1, wherein
said organic alkaline compound is composed of one or more ingredients selected from the group consisting of quaternary ammonium hydroxide and ethylenediamine.

3. The anisotropic silicon etchant composition according to claim 1, wherein
said inorganic alkaline compound is composed of one or more ingredients selected from the group consisting of sodium hydroxide, potassium hydroxide, ammonia and hydrazine.

4. The anisotropic silicon etchant composition according to claim 1, wherein
said silicon-containing compound is composed of at least one of a silicon-containing inorganic compound and a silicon-containing organic compound.

5. The anisotropic silicon etchant composition according to claim 1, wherein
said silicon-containing inorganic compound is composed of one or more ingredients selected from the group consisting of metal silicon, fumed silica, colloidal silica, silica gel, silica sol, diatomaceous earth, acid clay and activated clay, and
said silicon-containing organic compound is composed of one or more ingredients selected from the group consisting of quaternary ammonium salts of alkyl silicate and quaternary ammonium salt of alkyl silicic acid.

6. The anisotropic silicon etchant composition according to claim 1, further comprising
(c) a reducing compound.

7. The anisotropic silicon etchant composition according to claim 6, wherein
said reducing compound is composed of at least one ingredient selected from hydroxylamines, hydrazines, phosphates, hypophosphites, reducing sugars, ascorbic acid and glyoxylic acid and derivatives thereof.

8. The anisotropic silicon etchant composition according to claim 6, wherein
said reducing compound is composed of one or more ingredients selected from the group consisting of hydroxylamine, diethylhydroxylamine, hydroxylamine sulfate, hydroxylamine chloride, hydroxylamine oxalate, hydroxylamine phosphate, dimethylhydroxylamine hydrochloride, hydrazine, hydrazine monohydrochloride, hydrazine dihydrochloride, hydrazine sulfate, hydrazine carbonate, hydrazine phosphate, methyl hydrazine, methylhydrazine sulfate, ammonium dihydrogen phosphate, ammonium hypophosphite, maltose, lactose, melibiose, cellobiose, isomalto oligosaccharide, ascorbic acid and glyoxylic acid.
